(19) United States
(12) Patent Application Publication
(10) Pub. No.: US 2021/0307320 A1
(43) Pub. Date: Oct. 7, 2021

(54) MICROBIAL MICROCAPSULE COMPOSITIONS, METHODS AND RELATED METHODS

(71) Applicant: NEWLEAF SYMBIOTICS, INC., St. Louis, MO (US)

(72) Inventors: Kimberly ALLEN, St. Louis, MO (US); Desmond JIMENEZ, St. Louis, MO (US)

(21) Appl. No.: 17/056,797

(22) PCT Filed: May 29, 2019
(86) PCT No.: PCT/US2019/034395

§ 371 Date: Nov. 19, 2020

Related U.S. Application Data
(60) Provisional application No. 62/678,789, filed on May 31, 2018.

(51) Int. Cl. A01N 25/28; A01N 63/20; B01J 13/04; B01J 13/14

(52) U.S. Cl. CPC A01N 25/28; B01J 13/14; B01J 13/046; A01N 63/20

(57) ABSTRACT

Compositions that contain microencapsulated plant beneficial gram negative bacteria are provided, methods of using the compositions to treat plants or plant parts, and treated plants or plant parts are provided.

### CROSS-REFERENCE TO RELATED APPLICATIONS

This application claims the benefit of U.S. Provisional Patent Application No. 62/678,789, filed May 31, 2018, which is incorporated herein by reference in its entirety.

### BACKGROUND

Applying plant-growth promoting bacteria to crops is not a trivial task. Currently, inoculation with plant growth promoting bacteria is most commonly practiced in the cultivation of legumes, which are inoculated with rhizobacteria either by directly applying a liquid formulation to soil or seeds or by applying solid-phase peat-anchored bacteria to seed coats or pellets (Nussinovitch, A & Nussinovitch, A. Beads and special applications of polymers for agricultural uses. 2010). Both solid and liquid conventional inoculant formulations suffer from relatively short shelf life and high transportation costs (John, R P, Tyagi, R D, Brar, S K et al. Bio-encapsulation of microbial cells for targeted agricultural delivery. Critical Reviews in Biotechnology 2011; 31(3): 211-226)

### SUMMARY

Compositions comprising cross-linked monomer and/or protein microcapsules or cross-linked alginate microcapsules which encapsulates at least one plant beneficial gram negative bacterium, methods of making the compositions, plants and/or plant parts treated with the compositions, and methods of treating plants and/or plant parts are provided herein. Embodiments of the compositions, methods of making, plants and/or plant parts, and methods of treating the plants and/or plant parts include:

### Embodiment 1

A composition comprising a cross-linked alginate microcapsule (CLAM) which encapsulates at least one plant beneficial gram negative bacterium, wherein the microcapsule comprises at least one hydrophobic compound and wherein the composition further comprises a humectant.

### Embodiment 2

The composition of embodiment 1, wherein the hydrophobic compound is a latex polymer.

### Embodiment 3

The composition of embodiment 1 or 2, wherein the humectant is polyethylene glycol.

### Embodiment 4

The composition of embodiment 3, wherein the polyethylene glycol has an average molecular weight of about 40, 100, 200, or 300 to about 500, 600, 800, or 1000 Daltons.

### Embodiment 5

The composition of embodiment 4, wherein the polyethylene glycol has an average molecular weight of about 400 Daltons.

### Embodiment 6

The composition of any one of embodiments 1 to 5, further comprising additional agriculturally acceptable adjuvants and/or excipients.

### Embodiment 7

The composition of any one of embodiments 1 to 6, wherein the composition further comprises an insecticide, a nematicide, a fungicide, or any combination thereof.

### Embodiment 8

The composition of any one of embodiments 1 to 7, wherein the composition further comprises a plant fertilizer, a plant micronutrient, or any combination thereof.

### Embodiment 9

A method of making a composition comprising combining a cross-linked alginate microcapsule (CLAM) which encapsulates at least one plant beneficial gram negative bacterium with a humectant, wherein the microcapsule comprises at least one hydrophobic compound.

### Embodiment 10

The method of embodiment 9, wherein the CLAM and humectant are additionally combined with an agriculturally acceptable excipient, an additional agriculturally acceptable adjuvant, an insecticide, a nematicide, a fungicide, a plant fertilizer, a plant micronutrient, and/or any combination thereof.

### Embodiment 11

A plant part that is coated or partially coated with the composition of any one of embodiments 1 to 8.

### Embodiment 12

The plant part of embodiment 11, wherein the part is a seed, a leaf, a stem, a flower, a root, or a tuber.

### Embodiment 13

The plant part of embodiment 11 or 12, wherein the plant part is a corn, Brassica sp., alfalfa, rice, rye, sorghum, pearl millet, proso millet, foxtail millet, finger millet, sunflower, safflower, soybean, tobacco, potato, peanuts, cotton, sweet potato, cassava, coffee, coconut, pineapple, citrus trees, cocoa, tea, banana, avocado, fig, guava, mango, olive, papaya, cashew, macadamia, almond, sugar beet, sugarcane, oat, barley, tomato, lettuce, green bean, lima bean, pea, cucurbit, ornamental, or conifer plant part.

### Embodiment 14

A method of treating a plant or plant part comprising applying a first composition comprising the composition of any one of embodiments 1 to 8 of the plant or plant part.

### Embodiment 15

The method of embodiment 14, wherein the plant part is a corn, Brassica sp., alfalfa, rice, rye, sorghum, pearl millet, proso millet, foxtail millet, finger millet, sunflower, safflower, soybean, tobacco, potato, peanut, cotton, sweet potato, cassava, coffee, coconut, pineapple, citrus tree, cocoa, tea, banana, avocado, fig, guava, mango, olive, papaya, cashew, macadamia, almond, sugar beet, sugarcane, oat, barley, tomato, lettuce, green bean, lima bean, pea, cucurbit, ornamental, or conifer plant part.

### Embodiment 16

The method of embodiment 14 or 15, wherein the plant part is a seed.

### Embodiment 17

The method of any one of embodiments 14, 15, or 16, wherein a second composition comprising an insecticide, a nematicide, a fungicide, or any combination thereof is applied before, during, and/or after application of the first composition.

### Embodiment 18

The method of any one of embodiments 14, 15, 16, or 17, wherein a second composition comprising a plant fertilizer, a plant micronutrient, or any combination thereof is applied before, during, and/or after application of the first composition.

### Embodiment 19

A treated plant part obtained by the method of any one of embodiments 14 to 18.

### BRIEF DESCRIPTION OF THE DRAWINGS/FIGURES

FIG. 1. Survival of PPFM in CLAMs over one year of storage under ambient bench top conditions. Error bars indicate standard deviations from triplicate lots of CLAMs prepared with 0.1% CaHPO₄ (-□-) and 0.5% CaHPO₄ (-●-).

### DETAILED DESCRIPTION

The term “and/or” where used herein is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following embodiments: A, B, and C; A, B, or C: A or C; A or B; B or C; A and C; A and B; B and C; A (alone); B (alone); and C (alone).

Where a term is provided in the singular, embodiments comprising the plural of that term are also provided.

As used herein, the terms “include,” “includes,” and “including” are to be construed as at least having the features or encompassing the items to which they refer while not excluding any additional unspecified features or unspecified items.

As used herein, the phrase “modified CLMPMs” refers to a cross-linked monomer and/or protein microcapsule that encapsulates plant beneficial gram-negative bacteria.

As used herein, the phrase “modified CLAMs” refers to a cross-linked alginate microcapsule that encapsulates plant beneficial gram-negative bacteria. Modified CLMPMs include modified CLAMs.

As used herein, the phrase “plant beneficial gram-negative bacteria” refers to any gram negative bacterium that can elicit an improvement in yield, fruit maturation, biotic stress tolerance (e.g., insect, nematode, or fungal pathogen resistance), and/or abiotic stress tolerance (e.g., drought, salinity, freezing, or cold) when applied to a plant or plant part (e.g., seed) when compared to a mock or untreated control plant or plant part. Plant beneficial gram-negative bacteria include bacteria of the genera Methylobacterium, Methylorubrum, Pseudomonas, Rhizobium, Bnadyrhizobium, Mesorhizobium, Xanthomonas, Flavobacterium, Azospirillum, Azotobacter, Azomonas, Acinetobacter, Klebsiella, Pswehrobacter, Enterobacter, Stenotrophomonas, Sphingomonas, Serratia, Burkholderia, Ralstonia, and Erwinia.

As used herein, the term “Methylobacterium” refers to bacteria in the Methylobacteriaceae family, including species assigned to the Methylobacterium genus and species assigned to the proposed Methylorubrum genus (Green and Ardley, 2018). Methylobacterium includes pink-pigmented facultative methylotrophic bacteria and non-pink-pigmented Methylobacterium nodulans, as well as colorless mutants of Methylobacterium strains. For example, and not by way of limitation, “Methylobacterium” refers to bacteria of the species listed in Table 1 below as well as any new pink-pigmented facultative methylotrophic (PPFM) species that have not yet been reported or described that can be characterized as Methylobacterium or Methylorubrum based on phylogenetic analysis.

TABLE 1

| | |
|---|---|
| Methylobacterium adhaesivum | Methylobacterium oryzae |
| Methylobacterium aerolatum | Methylobacterium oxaldis |
| Methylobacterium aquaticum | Methethylobacterin persicinum |
| Methylobacterium brachiatum | Methylobacterium phyllosphaerae |
| Methylobacterium brachythecii | Methylobacterium phyllostachyos |
| Methylobacterium bullatum | Methylobacterium platani |
| Methylobacterium cerastii | Methylobecterium pseudosesicola |
| Methylobacterium currus | Methylobacterium radiotolerans |
| Methylobacterium dankookense | Methylobacterium soli |
| Methylobacterium frigidaeris | Methylobacterium specialis |
| Methylobacterium fujisawaense | Methylobacterinm tardum |
| Methylobacterium gnaphalii | Methylobacterium tarhaniae |
| Methylobacterium goesingense | Methylobecterium thuringiense |
| Methylobacterium gossipiicola | Methylobacterin trifolii |
| Methylobacterium gregans | Methylobacterium variabile |
| Methylobacterium haplocladii | Methylobacterium aminovorans |
| | (Methylorubrum aminovorans) |
| Methylobacterium hispanicum | Methylobacterium extorquens |
| | (Methylorubrum extorquens) |
| Methylobacterium indicum | Methylobacterium podarium |
| | (Methylorubrum podarium) |
| Methylobacterium iners | Methylobacterium populi |
| | (Methylorubrum populi) |
| Methylobacterium isbiliense | Methylobacterium pseudosasae |
| | (Methylorubrum pseudosasae) |
| Methylobacterium jeotgali | Methylobacterium rhodesianum |
| | (Methylorubrum rhodesianum) |
| Methylobacterium komagatae | Methylobacterium rhodinum |
| | (Methylorubrum rhodinum) |
| Methylobacterium longum | Methylobacterium salsuginis |
| | (Methylorubrum salsuginis) |
| Methylobacterium marchantiae | Methylobacterium suomiense |
| | (Methylorubrum suomiense) |
| Methylobacterium mesophilicum | Methylobacterium thiocyanatum |
| | (Methylorubrum thiocyanatum) |
| Methylobacterium nodulanus | Methylobacterium zatmanii |
| | (Methylorubrum zatmanii) |
| Methylobacterium organophilum | |

As used herein, “variant” when used in the context of a Methylobacterium isolate, refers to any isolate that has chromosomal genomic DNA with at least 99%, 99.9, 99.8, 99.7, 99.6%, or 99.5% sequence identity to chromosomal genomic DNA of a deposited Methylobacterium isolate provided herein. A variant of an isolate can be obtained from various sources including soil, plants or plant material and water, particularly water associated with plants and/or agriculture. Variants include derivatives obtained from deposited isolates.

As used herein, “derivative” when used in the context of a Methylobacterium isolate, refers to any strain that is obtained from a deposited Methylobacterium isolate provided herein. Derivatives of a Methylobacterium isolate include, but are not limited to, derivatives of the strain obtained by selection, derivatives of the strain selected by mutagenesis and selection, and genetically transformed strains obtained from the Methylobacterium isolate. A “derivative” can be identified, for example based on genetic identity to the strain from which it was obtained and will generally exhibit chromosomal genomic DNA with at least 99%, 99.9, 99.8, 99.7, 99.6%, or 99.5% sequence identity to chromosomal genomic DNA of the strain from which it was derived.

To the extent to which any of the preceding definitions is inconsistent with definitions provided in any patent or non-patent reference incorporated herein by reference, any patent or non-patent reference cited herein, or in any patent or non-patent reference found elsewhere, it is understood that the preceding definition will be used herein.

Methods for making the modified CLMPMs and modified CLAMs provided herein can be adapted in part from methods for producing claims with cargos (i.e., encapsulated compositions) other than plant beneficial gram negative bacteria that are disclosed in U.S. Pat. No. 9,700,519, which is specifically incorporated herein by reference in its entirety.

In certain embodiments, microcapsules can be prepared with a single polymerization step via spray drying of a formulation comprising one or more types of plant beneficial gram negative bacteria for encapsulation, at least one acid, at least one volatile base, a salt of an acid soluble multivalent ion and a cross-linkable monomer and/or protein (e.g., alginates, chitosan, collagen, latex, polygalacturonates (pectins), soy and/or whey proteins). In certain embodiments, cross-linking of the monomer and/or protein is achieved by internal gelation that takes place during spray drying thereby enclosing the cargo in a microcapsule. Ion mediated cross-linking of the monomer and/or protein molecules is initially prevented by pH control with the volatile base. In certain embodiments, timing of the cross-linking is also controlled by the timing of the volatilization of the base, which lowers the pH and releases the ions to spontaneously form cross-links between the monomer molecules. In certain embodiments, an aqueous formulation that contains the bacteria, sodium alginate, a calcium salt that is only soluble at reduced pH and an organic acid that has been neutralized to a pH just above the pKa is combined with a volatile base. Calcium ions needed for cross-linking become available during spray drying of the formulation by volatilization of the volatile base and the consequent drop in the pH of the spraying solution permitting cross-linking of the alginate and encapsulation of the bacteria.

In certain embodiments, methods of making a cross-linked alginate microcapsule (CLAM) which encapsulates at least one plant beneficial gram negative bacterium comprise: (i) atomizing a formulation comprising alginates, at least one acid neutralized with a volatile base, an insoluble salt of a multivalent ion, and at least one plant beneficial gram negative bacterium to form droplets; and, (ii) volatilizing said volatile base of said droplets to lower the pH of the formulation, which dissolves the otherwise insoluble salt, thereby making available said multivalent ion to cross-link the alginates and form the cross-linked alginate microcapsule which encapsulates at least one plant beneficial gram negative bacterium. In certain embodiments of the methods, the acid is selected from the group consisting of adipic acid, acrylic acid, glutaric acid, succinic acid, ascorbic acid, gallic acid, caffeic acid, and combinations thereof. In certain embodiments of the methods, the formulation further comprises at least one hydrophobic compound (e.g., a latex polymer). In certain embodiments of the methods, the volatile base is a base selected from the group of bases consisting of ammonia, methylamine, trimethylamine, ethylamine, diethylamine, and trimethylamine, and combinations thereof. In certain embodiments of the methods, the insoluble salt is selected from the group of salts consisting of dicalcium phosphate, calcium carbonate, calcium oxalate, calcium phosphate, calcium meta-silicate, calcium tartrate, and combinations thereof. In certain embodiments of the methods, the salt is calcium phosphate. In certain embodiments of the methods, the salt is calcium phosphate is at a concentration of about 0.05% to about 1.5% by weight in the formulation. In certain embodiments of the methods, the methods further comprise the step of sonicating the microcapsules. In certain embodiments of the methods, a population comprising a plurality of the cross-linked alginate microcapsules (CLAMs) wherein at least 90% or more of the CLAMs have a diameter of about 40 micrometers to about 80 micrometers is obtained by sonicating the microcapsules. In certain embodiments of the methods, about 0.05% to about 0.15% by weight calcium phosphate is used in the formulation and at least 90% or more of the modified CLAMs obtained following sonication have a diameter of about 50 micrometers to about 80 micrometers. In certain embodiments of the methods, about 0.4% to about 0.6% calcium phosphate is used in the formulation and at least 90% or more of the modifier CLAMs obtained following sonication have a diameter of about 40 micrometers to about 60 micrometers.

Suitable acids that can be used in the methods of making modified CLMPMs and modified CLAMs include carboxylic acids such as succinic acid and adipic acid, and phenolic acids such as, ascorbic acid, gallic acid and caffeic acid. In certain embodiments, the acid is an acid with a pK in the 4 to 5.5 range.

Volatile bases that can be used in the methods of making modified CLMPMs and modified CLAMs include ammonia hydroxide, and other volatile amines such as hydrazine, methylamine, trimethylamine, ethylamine, diethylamine, triethylamine, isobutylamine, N,N-diisopropylethylamine, morpholine, piperazine, and ethylenediamine.

Any salt of a divalent or trivalent ion that is soluble only under acidic conditions can be used in the methods of making modified CLMPMs and modified CLAMs. For example, salts of barium (Ba²⁺), beryllium (Be²⁺), calcium (Ca²⁺), chromium (Cr²⁺), cobalt (Co²⁺), copper (Cu²⁺), iron (Fe²⁺), lead (Pb²⁺), magnesium (Mg²⁺), mercury (Hg²⁺), strontium (Sr²⁺), tin (Sn²⁺), and/or zinc (Zn²⁺) can be used. In certain embodiments, the insoluble salt is dicalcium phosphate, calcium carbonate, and/or calcium oxalate.

In certain embodiments, hydrophobic compounds that include polymeric latex, waxes and/or wax emulsions can be added to the formulation before atomization (e.g., spray drying) in the methods of making modified CLMPMs and modified CLAMs.

In certain embodiments, a formulation composed of plant beneficial gram negative bacteria, alginates, adipic acid (pKa=4.43 and 5.41 at 25° C.) or succinic acid (pKa=4.16 and 5.61 at 25° C.), and a hydrophobic agent, and a calcium salt of low solubility in water, where the pH is controlled by the addition of ammonium hydroxide, is used in the methods provided herein to form modified CLAMs. In certain embodiments, the hydrophobic agent is a latex polymer. Alginates are mixed polysaccharides of beta (1-4) mannuronic acids and beta (1-4) guluronic acids. In a solution with a pH>4, the polysaccharide backbone is negatively charged, with pKa's of 4 and 3.2 for the mannuronic acid and guluronic acid residues, respectively. The ammonium hydroxide base is titrated to adjust the pH of the solution to above the second pKa of the acid, thus minimizing the hydrogen ion concentration in the solution and maintaining the calcium as an insoluble salt (i.e. not available for cross-linking the alginate monomers). In certain embodiments, the solution in this fluid state is pumped through the nozzle of the spray dryer, where it is effectively atomized. Upon atomization, the volatile ammonia is vaporized which reduces the pH (hydrogen ions are released into solution) and in turn releases Ca²⁺ ions that electrostatically cross-link the negatively charged backbones of the alginates. In certain embodiments, an alginic acid (alginate) solution (4%) can be used that contains alginic acid, unavailable calcium ions in the form of dicalcium phosphate, and citrate, a chelating agent to complex low concentrations of calcium ions. Biomolecules or other molecules to be encapsulated are added to the alginic acid solution.

Droplets of the formulation can be formed through the use of an annular nozzle, spinning disc technology or some other fine droplet forming device such as spray-drying. In certain embodiments, the selected monomers and/or proteins, acids, bases, salts, bacteria, and other components are mixed together to produce a formulation to be atomized and spray dried. In certain embodiments, droplets that are formed in the spray drying apparatus are heated to further volatilize the volatile base in the formulation to initiate the polymerization of the monomers and the formation of the modified CLMPMs or modified CLAMs. The volatilization of the base changes the pH of the formulation allowing the salt to disassociate so that multivalent ions are available for cross-linking of the monomers. In certain embodiments, a fluidized bed can be used in a process to prepare modified CLMPMs or modified CLAMs.

In certain embodiments, modified CLAMs can be obtained spray-drying of an aqueous formulation that contains one or more types of plant beneficial gram-negative bacteria, sodium alginate, a calcium salt that is only soluble at reduced pH and an organic acid that has been neutralized to a pH just above the pKa with a volatile base. Under these conditions, the calcium salt is insoluble and calcium ions are not available for cross-linking. In certain embodiments, formulation in this fluid state is pumped through the nozzle of the spray dryer, where it is effectively atomized. Upon atomization, the volatile base is vaporized, which reduces the pH (hydrogen ions are released into solution) and in turn releases calcium ions from the calcium salt that are now available to cross-link the alginate. In certain embodiments, incorporation of an additional hydrophobic polymer to the formulation allows for the control of hydration properties of the particles to control the release of the encapsulated plant beneficial gram negative bacteria. In certain embodiments provided herein, the modified CLMPMS or modified CLAMs are subjected to sonication. Such sonication can provide populations of CLMPMS wherein at least 70%, 80%, 90% or more of the CLMPMs have a diameter of about 40 micrometers to about 80 micrometers. In certain embodiments, such sonication can provide populations of CLMPMS wherein at least 90% or more of the CLMPMs have a diameter of about 50 micrometers to about 80 micrometers or wherein at least 90% or more of the CLMPMs have a diameter of about 40 micrometers to about 60 micrometers. In certain embodiments, 0.05% to about 0.15% by weight calcium phosphate is used in the formulation used to make the CLMPMS and wherein at least 90% or more of the CLMPMs have a diameter of about 50 micrometers to about 80 micrometers. In certain embodiments, about 0.4% to about 0.6% calcium phosphate is used in the formulation used to make the CLMPMs and at least 90% or more of the CLMPMs have a diameter of about 40 micrometers to about 60 micrometers. In certain embodiments, a population comprising a plurality of the cross-linked alginate microcapsules (CLAMs) wherein at least 90% or more of the CLAMs have a diameter of about 40 micrometers to about 80 micrometers are provided. In certain embodiments, a population comprising at least 90/o or more of the CLAMs have a diameter of about 50 micrometers to about 80 micrometers or wherein at least 90% or more of the CLAMs have a diameter of about 40 micrometers to about 60 micrometers. In certain embodiments, a population comprising a plurality of the CLMPMs wherein at least 90% or more of the CLMPMs have a diameter of about 40 micrometers to about 80 micrometers is provided. In certain embodiments, a population comprising at least 90% or more of the CLMPMs have a diameter of about 50 micrometers to about 80 micrometers or wherein at least 90% or more of the CLMPMs have a diameter of about 40 micrometers to about 60 micrometers is provided. Compositions comprising the populations of CLMPMs and an agriculturally acceptable excipient and/or adjuvant are also provided.

The CLMPMs, CLAMs, and compositions provided herein can comprise one or more plant beneficial gram-negative bacteria that include bacteria of the genus Methylobacterium, Pseudomonas, Rhizobium, Bradyrhizobium, Mesorhizobium, Xanthomonas, Flavobacterium, Azospirillum, Azotobacter, Azomonas, Acinetobacter, Klebsiella, Psychrobacter, Enterobacter, Stenotrophomonas, Sphingomonas, Serratia, Burkholderia, Ralstonia, and Erwinia, and combinations thereof. Methylobacterium that can be used include, but are not limited to, M. aminovorans, M. chloromethanicum, M. dichloromethanicum, M. extorquens, M. fujisawaense, M. mesophilicum, M. organophilum, M. radiotolerans, M. rhodesianum, M. rhodinum, M thiocyanatum, M. nodulans, M. cerastii, M. gossipiicola, Methylobacterium sp. strain LMG6378, M. phyllosphaerae, M. oryzae, M. platani, M populi, and M. zatmanii. Compositions provided herein can comprise Methylobacterium sp. isolates provided in the following Table 2 or variants of the isolates. In certain embodiments, one or more of the Methylobacterium strains used in the methods can be a variant that comprises total genomic DNA (chromosomal and plasmid DNA) or average nucleotide identity (ANI) with at least 99%, 99.9, 99.8, 99.7, 99.6%, or 99.5% sequence identity or ANI to total genomic DNA of ISO01 (NRRL B-50929), ISO02 (NRRL B-50930), ISO03 (NRRL B-50931), ISO04 (NRRL B-50932), ISO05 (NRRL B-50933), ISO06 (NRRL B-50934), ISO07 (NRRL B-50935), ISO08 (NRRL B-50936), ISO09 (NRRL B-50937), ISO10 (NRRL B-50938), ISO11 (NRRL B-50939), ISO12 (NRRL B-50940), ISO13 (NRRL B-50941), ISO14 (NRRL B-50942), or ISO16 (NRRL B-67340). In certain embodiments, the percent ANI can be determined essentially as disclosed by Konstantinidis et al. (2006). In certain embodiments, such variants are derivatives which can include but are not limited to, derivatives of the isolates obtained by selection, derivatives of the isolates selected by mutagenesis and selection, and genetically transformed derivatives obtained from the isolates, where the derivatives exhibit resistance to bacteriocidal agents, herbicides (e.g., glyphosate), and/or exhibit other plant beneficial properties that include improved plant yield, early vigor, root growth, shoot growth, and/or fruit maturation in comparison to an untreated or mock-treated control plant.

TABLE 2
Methylobacterium sp. isolates

| | USDA | |
|---|---|---|
| | ARS | |
| | NRRL | |
| Strain No. | No.¹ | Strain Source |
| ISO01 | NRRL | Obtained from a soybean plant grown |
| (Methylobacterium | B-50929 | in Saint Louis County, Missouri, USA |
| sp. #1) | | |
| ISO02 | NRRL | Obtained from a weed gown in |
| (Methylobacterium | B-50930 | Saint Louis County, Missouri, USA |
| sp. #2) | | |
| ISO03 | NRRL | Obtained from a mint plant grown |
| (Methylobacterium | B-50931 | in Saint Louis County, Missouri, USA |
| sp. #1) | | |
| ISO04 | NRRL | Obtained from a soybean plant grown |
| (Methylobacterium | B-50932 | in Saint Louis County, Missouri, USA |
| sp. #4) | | |
| ISO05 | NRRL | Obtained from a broccoli plant grown |
| (Methylobacterium | B-50933 | in Saint Louis County, Missouri, USA |
| sp. #5) | | |
| ISO06 | NRRL | Obtained from a corn plant grown in |
| (Methylobacterium | B-50934 | Saint Louis County, Missouri, USA |
| sp. #6) | | |
| ISO07 | NRRL | Obtained from a corn plant grown in |
| (Methylobacterium | B-50935 | Saint Louis County, Missouri, USA |
| sp. #7) | | |
| ISO08 | NRRL | Obtained from a corn plant grown in |
| (Methylobacterium | B-50936 | Saint Louis County, Missouri, USA |
| sp. #8) | | |
| ISO09 | NRRL | Obtained from a corn plant grown in |
| (Methylobacterium | B-50937 | Saint Louis County, Missouri, USA |
| sp. #9) | | |
| ISO10 | NRRL | Obtained from a corn plant grown in |
| (Methylobacterium | B-50938 | Saint Louis County, Missouri, USA |
| sp. #10) | | |
| ISO11 | NRRL | Obtained from a lettuce plant grown |
| (Methylobacterium | B-50939 | in Saint Louis County, Missouri, USA |
| sp. #11) | | |
| ISO12 | NRRL | Obtained from a corn plant grown in |
| (Methylobacterium | B-50940 | Saint Louis County, Missouri, USA |
| sp. #12) | | |
| ISO13 | NRRL | Obtained from a tomato plant grown |
| (Methylobacterium | B-50941 | in Saint Louis County, Missouri, USA |
| sp. #13) | | |
| ISO14 | NRRL | Obtained from a tomato plant grown |
| (Methylobacterium | B-50942 | in Saint Louis County, Missouri, USA |
| sp. #14) | | |
| ISO16 | NRRL | Obtained from a yucca plant grown in |
| (Methylobacterium | B-67340 | Saint Louis County, Missouri, USA |
| sp. #16) | | |

¹Deposit number for strains deposited with the AGRICULTURAL RESEARCH SERVICE CULTURE COLLECTION (NRRL) of the National Center for Agricultural Utilization Research, Agricultural Research Service, U.S. Department of Agriculture, 1815 North University Street, Peoria, Illinois 61604 U.S.A, under the terms of the Budapest Treaty on the International Recognition of the Deposit of Microorganisms for the Purposes of Patent Procedure. Subject to 37 CFR §1.808(b), all restrictions imposed by the depositor on the availability to the public of the deposited material will be irrevocably removed upon the granting of any patent from this patent application.

In certain embodiments, compositions comprising the modified CLMPMs or modified CLAMs can have a titer of about 1×10², 1×10³, 1×10⁴, or 1×10⁵ to about 1×10⁶, 1×10⁷, 1×10⁸, 1×10⁹, 1×10¹⁰, 1×10¹¹, or 5×10¹¹ colony forming units (CFU) of the plant beneficial gram-negative bacteria (e.g., Methylobacterium) per gram of the composition or per milliliter of the composition. In certain embodiments, compositions comprising the modified CLMPMs or modified CLAMs can have a titer of about 1×10⁶, 1×10⁷, or 1×10⁸ to about 1×10⁹, 1×10¹⁰, 1×10¹¹, or 5×10¹¹ colony forming units (CFU) of the plant beneficial gram-negative bacteria (e.g., Methylobacterium) per gram of the composition or per milliliter of the composition.

In certain embodiments, the modified CLMPMs or modified CLAMs can have a titer of about 1×10², 1×10³, 1×10⁴, or 1×10⁵ to about 1×10⁶, 1×10⁷, 1×10⁸, 1×10⁹, 1×10¹⁰, 1×10¹¹, or 5×10¹¹ colony forming units (CFU) of the plant beneficial gram-negative bacteria (e.g., Methylobacterium) per gram of the composition or per milliliter of the composition. In certain embodiments, the modified CLMPMs or modified CLAMs can have a titer of about 1×10⁶, 1×10⁷, or 1×10⁸ to about 1×10⁹, 1×10¹⁰, 1×10¹¹, or 5×10¹¹ colony forming units (CFU) of the plant beneficial gram-negative bacteria (e.g., Methylobacterium) per gram of the composition or per milliliter of the composition.

In certain embodiments, compositions comprising the modified CLMPMs, modified CLAMs, or aforementioned populations thereof can further comprise a humectant. Without seeking to be limited by theory, it is believed that inclusion of the humectant can improve shelf life of the encapsulated plant beneficial gram negative bacteria, and can act as a stabilizer in a seed treatment process. In certain embodiments, the humectant is polyethylene glycol (PEG). The PEG can have a linear, branched, star, or comb configuration. Humectants that can be used include: various polyols such as polyethylene glycol, propylene glycol, hexylene glycol, butylene glycol, ethylene glycol, and polyvinyl alcohol; glycerin, polyvinyl pyrrolidone, sugar alcohols, such as glycerol, sorbitol, xylitol and maltitol; polymeric polyols, such as polydextrose; alpha hydroxy acids, such as lactic acid, egg yolk and egg white, aloe vera gel, glyceryl triacetate, honey, lithium chloride, molasses, urea, quillaia and sodium hexametaphosphate E452i. Combinations of the aforementioned humectants can also be used. In certain embodiments, the polyethylene glycol has an average molecular weight of about 40, 100, 200, or 300 to about 500, 600, 800, or 1000 Daltons. In certain embodiments, the polyethylene glycol has an average molecular weight of about 400 Daltons. Amounts of PEG provided in the composition comprising the modified CLMPMs or modified CLAMs can range from about 0.01%, 0.05, or 0.1% to about 1%, 2%, or 5% by weight.

In certain embodiments, compositions comprising the modified CLMPMs or modified CLAMs can further comprise an additional active ingredient which may be, for example, a pesticide or a second biological. The pesticide may be, for example, an insecticide, a fungicide, an herbicide, or a nematicide. The biological could be a biocontrol microbe.

Non-limiting examples of insecticides and nematicides include carbamates, diamides, macrocyclic lactones, neonicotinoids, organophosphates, phenylpyrazoles, pyrethrins, spinosyns, synthetic pyrethroids, tetronic and tetramic acids. In particular embodiments insecticides and nematicides include abamectin, aldicarb, aldoxycarb, bifenthrin, carbofuran, chlorantraniliporle, chlothianidin, cyfluthrin, cyhalothrin, cypermethrin, deltamethrin, dinotefuran, emamectin, ethiprole, fenamiphos, fipronil, flubendiamide, fosthiazate, imidacloprid, ivermectin, lambda-cyhalothrin, milbemectin, nitenpyram, oxamyl, permcthrin, tioxazafen, spinetoram, spinosad, spirodichlofen, spirotetramat, tefluthrin, thiacloprid, thiamethoxam, and thiodicarb,

Non-limiting examples of useful fungicides include aromatic hydrocarbons, bcnzimidazoles, benzthiadiazolc, carboxamides, carboxylic acid amides, morpholines, phenylamides, phosphonates, quinone outside inhibitors (e.g. strobilurins), thiazolidines, thiophanates, thiophene carboxamides, and triazoles. Particular examples of fungicides include acibenzolar-S-methyl, azoxystrobin, benalaxyl, bixafen, boscalid, carbendazim, cyproconazole, dimethomorph, epoxiconazole, fluopyram, fluoxastrobin, flutianil, flutolanil, fluxapyroxad, fosetyl-Al, ipconazole, isopyrazam, kresoxim-methyl, mefenoxam, metalaxyl, metconazole, myclobutanil, orysastrobin, penflufen, penthiopyrad, picoxystrobin, propiconazole, prothioconazole, pyraclostrobin, sedaxane, silthiofam, tebuconazole, thifluzamide, thiophanate, tolclofos-methyl, trifloxystrobin, and triticonazole.

Non-limiting examples of herbicides include ACCase inhibitors, acetanilides, AHAS inhibitors, carotenoid biosynthesis inhibitors, EPSPS inhibitors, glutamine synthetase inhibitors, PPO inhibitors, PS II inhibitors, and synthetic auxins, Particular examples of herbicides include acetochlor, clethodim, dicamba, flumioxazin, fomesafen, glyphosate, glufosinate, mesotrione, quizalofop, saflufenacil, sulcotrione, and 2,4-D.

In some embodiments, the composition or method disclosed herein may comprise an additional active ingredient which may be a second biological. The second biological could be a biological control agent, other beneficial microorganisms, microbial extracts, natural products, plant growth activators or plant defense agent. Non-limiting examples of biological control agents include bacteria, fungi, beneficial nematodes, and viruses.

In certain embodiments, the second biological can be Methylobacterium selected from the group consisting of ISO01 (NRRL B-50929), ISO02 (NRRL B-50930), ISO03 (NRRL B-50931), ISO04 (NRRL B-50932), ISO05 (NRRL B-50933), ISO06 (NRRL B-50934), ISO07 (NRRL B-50935), ISO08 (NRRL B-50936), ISO09 (NRRL B-50937), ISO10 (NRRL B-50938), ISO11 (NRRL B-50939), ISO12 (NRRL B-50940), ISO13 (NRRL B-50941), ISO14 (NRRL B-50942), or ISO16 (NRRL B-67340). In certain embodiments, the second biological can be a Methylobacterium having chromosomal genomic DNA with at least 99%, 99.9, 99.8, 99.7, 99.6%, or 99.5% sequence identity to chromosomal genomic DNA of ISO01 (NRRL B-50929), ISO02 (NRRL B-50930), ISO03 (NRRL B-50931), ISO04 (NRRL B-50932), ISO05 (NRRL B-50933), ISO06 (NRRL B-50934), ISO07 (NRRL B-50935), ISO08 (NRRL B-50936), ISO09 (NRRL B-50937), ISO10 (NRRL B-50938), ISO11 (NRRL B-50939), ISO12 (NRRL B-50940), ISO13 (NRRL B-50941), ISO14 (NRRL B-50942), or ISO16 (NRRL B-67340).

In certain embodiments, the second biological can be a bacterium of the genus Actinomycetes, Agrobacterium, Arthrobacter, Alcaligenes, Aureobacterium, Azobacter, Beijerinckia, Brevibacillus. Burkholderia, Chromobacterium, Clostridium, Clavibacter, Comomonas, Corynebacterium, Curtobacterium, Enterobacter, Flavobacterium, Gluconobacier, Hydrogenophage, Klebsiella, Methylobacterium, Paenibacillus, Pasteuria, Phingobacterium, Photorhabdus, Phyllobacterium, Pseudomonas, Rhizobium, Bradyrhizobium, Serratia, Stenotrophomonas, Variovorax, and Xenorhadbus. In particular embodiments the bacteria is selected from the group consisting of Bacillus amyloliquefaciens, Bacillus cereus, Bacillus firmus, Bacillus, lichenformis, Bacillus pumilus, Bacillus sphaericus, Bacillus subtilis, Bacillus thuringiensis, Chromobacterium suttsuga, Pasteuria penetrans, Pasteuria usage, and Pseudomona fluorescens.

In certain embodiments the second biological can be a fungus of the genus Alternaria, Ampelomyces, Aspergillus, Aureobasidium, Beauveria, Colletotrichum, Coniorhvrium, Gliocladium, Metarhisium, Muscodor, Paecilonyces, Trichoderma, Typhula, Ulocladium, and Verticilium. In particular embodiments the fungus is Beauveria bassiana, Coniothyrium minitans, Gliocladium vixens, Muscodor albus, Paecilomtyces lilacinus, or Trichoderma polysporum.

In further embodiments the second biological can be a plant growth activator or plant defense agent including, but not limited to harpin, Reynoutria sachalinensis, jasmonate, lipochitooligosaccharides, and isoflavones.

In further embodiments, the second biological can include, but are not limited to, various Bacillus sp., Pseudomonas sp., Coniothyrium sp., Pantoea sp., Streptomyces sp., and Trichoderma sp. Microbial biopesticides can be a bacterium, fungus, virus, or protozoan. Particularly useful biopesticidal microorganisms include various Bacillus subtilis, Bacillus thuringiensis, Bacillus pumilis, Pseudomonas syringae, Trichoderma harzianum, Trichoderma virens, and Sireptomyces lydicus strains. Other microorganisms that are added can be genetically engineered or wild-type isolates that are available as pure cultures. In certain embodiments, it is anticipated that the biological or biocontrol agent can be provided in the fermentation broth, fermentation broth product, or composition in the form of a spore.

In certain embodiments, the fermentation broth, fermentation broth product, or compositions that comprise yield enhancing Methylobacterium sp. can further comprise one or more introduced additional active ingredient or microorganism of pre-determined identity other than Methylobacterium.

Compositions comprising modified CLMPMs or modified CLAMs provided herein can include certain adjuvants and/or excipients and/or comprise CLMPMs or CLAMs encapsulating certain adjuvants and/or excipients. Such adjuvants are components added to the composition that can preserve and/or potentiate the biological activity of the modified CLMPMs or modified CLAMs. Broad categories of adjuvants that can be used include agents that promote distribution or retention of the composition or biological activity of the composition onto or within a treatment target (e.g., standing water, soil, and/or a plant part). Surfactants that can be used as adjuvants include anionic, cationic, nonionic and amphoteric surfactants, block polymers, polyelectrolytes, and mixtures thereof. Such surfactants can serve as an emulsifier, dispersant, solubilizer, wetter, penetration enhancer, and/or protective colloid in compositions comprising the modified CLMPMs or modified CLAMs provided herein. Anionic surfactants that can be used include alkali, alkaline earth or ammonium salts of sulfonates (e.g., alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates, sulfosuccinamate-sulfates, or combinations thereof), sulfates (e.g., sulfates of fatty acids and oils, of ethoxylated alkylphenols, of alcohols, of ethoxylated alcohols, or of fatty acid esters), phosphates (e.g., phosphate esters), carboxylates (e.g. alkyl carboxylates, carboxylated alcohol ethoxylates, or carboxylated alkylphenol ethoxylates), and mixtures thereof. Other useful adjuvants include sticking agents (e.g., binders or tackifiers) particularly in embodiments where the composition is for application to a plant part (e.g., foliage, seed, roots, and the like) or soil. Sticking agents include polyvinylpyrrolidones, polyvinylacetates, polyvinyl alcohols, polyacrylates, biological or synthetic waxes, and cellulose ethers.

Compositions comprising the modified CLMPMs or modified CLAMs provided herein can include certain excipients. In certain embodiments, such excipients are components added to the composition that are essentially inert and serve as bulking agents. In certain embodiments, a component of the fermentation broth product can serve as an excipient and/or an adjuvant. Examples of excipients used herein include mineral earths (e.g., silicates, silica gels, talc, kaolins, limestone, lime, chalk, clays, dolomite, diatomaceous earth, bentonite, calcium sulfate, magnesium sulfate, magnesium oxide), polysaccharides (e.g., cellulose, starch); and various plant products (e.g., bagasse, wood chips, or any other lignocellulosic biomass) and mixtures of any of the foregoing materials.

In certain embodiments, compositions comprising the modified CLMPMs can be in liquid, slurry, granular or powder form. In certain embodiments the modified CLMPMs or modified CLAMs can be in an aqueous liquid, a non-aqueous liquid, or an emulsion comprising an aqueous and an immiscible and/or partially miscible non-aqueous liquid. Non-aqueous liquids that are used alone or in emulsions include mineral oils (e.g., kerosene and/or diesel oil); animal oils, plant oils (e.g., corn, soy, castor, rapeseed and/or any other oilseed oil, and the like); aliphatic, cyclic and aromatic hydrocarbons (e.g., toluene, paraffin, tetrahydronaphthalene, and/or alkylated naphthalenes); alcohols (e.g., propanol, butanol, benzylalcohol, and/or cyclo-hexanol); glycols; DMSO; ketones (e.g., cyclohexanone; esters (e.g., lactates, carbonates, fatty acid esters, gamma-butyrolactone); saturated and/or unsaturated fatty acids (e.g., stearic, palmitic, linolenic, linoleic, oleic, and the like); phosphonates; amines; amides (e.g., N-methylpyrrolidone, fatty acid dimethylamides); and mixtures of any of the foregoing materials. In certain embodiments, the emulsion can contain an emulsion stabilizer (e.g., any amphipathic of other agent which promotes dispersal of a non-aqueous liquid in an aqueous liquid to maintain an emulsion).

In certain embodiments, plants and/or plant parts are treated by applying the compositions provided herein as a spray. Such spray applications include, but are not limited to, treatments of a single plant part or any combination of plant parts. Spraying can be achieved with any device that will distribute the compositions to the plant and/or plant part(s). Useful spray devices include a boom sprayer, a hand or backpack sprayer, crop dusters (i.e. aerial spraying), and the like. Spraying devices and or methods providing for application of the compositions to either one or both of the adaxial surface and/or abaxial surface can also be used. Plants and/or plant parts that are at least partially coated with the compositions are also provided herein. In some embodiments, the plant part is a seed. Partial coating of a plant or a plant part includes, but is not limited to coating at least about 5%, 10%, 20%, 30%, 40%, 50%, 60%, 70%, 80%, 90%, 95%, 98%, 99%, or about 99.5% of the surface area of the plant or plant part. Also provided are processed plant products that contain the modified CLMPMs or modified CLAMs. Seeds that have been at least partially coated with the fermentation broth products or compositions are thus provided. Partial coating of a seed includes, but is not limited to coating at least about 5%, 10%, 20%, 30%, 40%, 50%, 60%, 70%, 80%, 90%, 95%, 98%, 99%, or about 99.5% of the surface area of the seed. Also provided herein are processed plant products that comprise the compositions provided herein.

In certain embodiments, seeds are treated by exposing the seeds to the compositions provided herein. Seeds can be treated with the compositions provided herein by methods including, but not limited to, imbibition, coating, spraying, and the like. Seed treatments can be effected with both continuous and/or batch seed treaters. In certain embodiments, the coated seeds may be prepared by slurrying seeds with a coating composition containing the compositions and air drying the resulting product. Air drying can be accomplished at any temperature that is not deleterious to the seed or the plant beneficial gram negative bacteria, but will typically not be greater than 30 degrees Centigrade. The proportion of coating that comprises a solid substance and plant beneficial gram negative bacteria includes, but is not limited to, a range of 0.1 to 25% by weight of the seed, 0.5 to 5% by weight of the seed, and 0.5 to 2.5% by weight of seed. In certain embodiments, a solid substance used in the seed coating or treatment will have plant beneficial gram negative bacteria adhered thereon. Various seed treatment compositions and methods for seed treatment disclosed in U.S. Pat. Nos. 5,106,648, 5,512,069, and 8,181,388 are incorporated herein by reference in their entireties and can be adapted for use with the compositions provided herein.

### EXAMPLES

The following examples are included to demonstrate certain embodiments. However, those of skill in the art should, in light of the instant disclosure, appreciate that many changes can be made in the specific embodiments that are disclosed, while still obtaining like or similar results, without departing from the scope of this disclosure.

### Example 1 Preparation of Microbial Pellets

Methylobacterium (Pink Pigmented Facultative Methylotrophs or PPFM) were grown using amended ammonia mineral salts media containing 15 g/L of glutamic acid and 10 g/L of Bacto soytone. Media were adjusted to pH 6.8 using 1 M NaOH. Frozen cell concentrates were used to inoculate 500 mL baffled Erlenmeyer flasks containing 300 mL of sterile media. Shake flask cultures were grown using a rotating shaker incubator at 200 rpm and 30° C. for 38 hours. Whole broth was sampled aseptically in a biological hood for colony forming unit (CFU) enumeration. Log phase cultures were harvested by centrifugation at 5,000 rpm in a fixed angle rotor Avanti centrifuge (ThemoFisher, Waltham, Mass.) for 5 minutes at 4° C. After centrifugation, the cell pellets were re-suspended in 300 mL of an alginate solution described in Example 2.

### Example 2 Preparation of Spray-Dried Powders

Dry cross-linked alginate microcapsules were prepared by spray-drying a well-mixed suspension of 2.0% (w/w) sodium alginate, 1.0% (w/w) succinic acid (adjusted to pH 5.6 with ammonium hydroxide), and insoluble calcium phosphate dibasic dihydrate (CaHPO₄). To achieve different extents of calcium alginate cross-linking, the concentration of CaHPO₄ in the spray-dryer inlet suspension was either 0.5% or 0.1% (w/w). The microorganism pellet (prepared as described in Example 1) was dispersed in this inlet suspension, which was subsequently pumped into a Buchi B290 laboratory spray-dryer (New Castle, Del.) to produce dry, bacteria-loaded microcapsules. All formulations were prepared under identical operating conditions: inlet air temperature was set to 130° C., aspirator airflow rate was set to maximum (35 m3/h), peristaltic pump was set to 45% of maximum, and nozzle air flow was set to 50 mm on the Q-flow indicator. Under these conditions, the outlet temperatures ranged from 49-53° C.

During spray-drying, the suspension was atomized at the nozzle into minute droplets. As these droplets dried into microcapsules, the vaporization of the volatile base reduced the pH of the droplets, dissolving CaHPO₄ and availing Ca-ions to cross-link the alginate. Thus, the bacteria in the feed stream exit the spray-dryer encapsulated in CLAMs in the form of a dry powder that is insoluble in water. Triplicate lots of each powder (0.1% and 0.5% CaHPO₄) were prepared and analyzed in triplicate. Formulated to achieve a relatively moderate level of cross-linking, 0.1% Ca PPFM-microcapsules (i.e., modified CLAMS encapsulating the PPFM) were prepared with 0.1% insoluble CaHPO₄ in the inlet suspension. A relatively high level of cross-linking was targeted in 0.5% Ca PPFM-microcapsules (i.e., modified CLAMS encapsulating the PPFM) containing 0.5% CaHPO₄ in the spray-dryer inlet suspension. Spray dried powders were stored at room temperature in clear glass vials, with exposure to ambient light.

### Example 3 Characterization of Spray-Dried Powders

Scanning electron micrography showed that dry PPFM-microcapsules ranged in size from approximately 1 to 15 μm. PPFM-microcapsules generally exhibited spherical morphology, and the extent of cross-linking level did not appear to influence particle morphology.

The particle size distributions of non-hydrated microcapsules were determined using a Mastersizer 2000 particle analyzer with Hydro μP dispersion unit (Malvern Instruments, Worcestershire, UK). Spray dried powders were dispersed in propan-2-ol and added to the dispersion unit according to manufacturer guidelines. A refractive index of 1.51 and an absorption index of 0.1 were assumed for the powder, and a general purpose spherical model was selected. Measurements were made while the dispersion unit pump was set to 2500 rpm. Prior to each measurement, samples were sonicated in the dispersion unit at 50% intensity for 10.0 minutes to break up aggregates. Each sample was measured in triplicate (each replicate returned ten measurements), and Malvern software was used to calculate an average from the 30 distributions. The reported size parameters are the average±standard deviation for the three replicates.

In addition, particle size distributions were determined as powders hydrated and released PPFM. For this analysis, powders were suspended in water and added to the dispersion unit, with water as the dispersing fluid. Measurements were performed every 2 min as the particles circulated through the dispersion unit (no sonication).

The CaHPO₄ content of the spray-dryer inlet suspension was found to influence the extent of alginate cross-linking in the microcapsule matrix. The extent of cross-linking was measured as the percentage of total alginate that leached out from the alginate matrix when the PPFM-microcapsules were suspended in water for 2 hours. The 0.5% Ca PPFM-microcapsules released 23.7±2.0% of total alginate into solution, significantly less than the 52.7±5.2% of total alginate released from 0.1% Ca PPFM-microcapsules, indicating that the 0.5% Ca PPFM-microcapsules contained a greater fraction of insoluble, cross-linked alginate. The level of cross-linking had no significant influence on the wet basis moisture content (6.60±0.26% and 6.98±0.67% for 0.1% Ca and 0.5% Ca PPFM-microcapsules, respectively) or the recovery yield of powder relative to dry solids in the feed (51.8±2.2% and 54.3±1.7% for 0.1% Ca and 0.5% Ca PPFM-microcapsules, respectively).

PPFM-microcapsules tended to form particle aggregates, as evidenced by shoulders spanning from approximately 100 to 1000 μm in the particle size distributions. Applying sonication to the dispensed PPFM-microcapsules narrowed the particle size distributions by eliminating the shoulder, yielding particle size measurements that generally agree with SEM observations. The sonication step reduced the 90th percentile diameter from 183±35 μm to 66±13 μm and from 171±14 μm to 51±8 μm for 0.1% and 0.5% Ca PPFM-microcapsules, respectively. CaHPO₄ content had minimal effect on the particle size of PPFM-microcapsules.

### Example 4 Release of Bacteria from PPFM-Microcapsoles

The extent of alginate cross-linking did not affect particle size, but it appeared to govern the release of PPFMs from microcapsules. When suspended in water, the size distributions of 0.5% and 0.1% Ca PPFM-CLAMs (i.e., modified CLAMS encapsulating the PPFM) each converged to bimodal distributions within approximately 20 minutes of continuous measurement. The size distributions for PPFM-microcapsules featured two peaks centered at 10-20 μm and 1-2 μm, likely corresponding to the PPFM-microcapsules and PPFMs released into the fluid, respectively. For the moderately cross-linked 0.1% Ca PPFM-microcapsules after 20-minute hydration, the 1-2 μm bacteria peak was of greater magnitude relative to the 10-20 μm peak corresponding to the microcapsules. The distribution's convergence to the bacteria peak suggested that the moderately cross-linked 0.1% Ca PPFM-microcapsules may rapidly break down in water and release a considerable portion of their cargo. Comparatively, 0.5% Ca PPFM-microcapsules appeared to release fewer bacteria, as the peak corresponding to the bacteria remained low in magnitude relative to the peak corresponding to the microcapsules. Thus, a more extensively cross-linked alginate matrix appeared to limit the immediate release of cargo, most likely because less of the alginate matrix solubilized into the surrounding solution (23.7±2.0% of the alginate matrix compared to 52.7±5.2% for 0.1% Ca PPFM-microcapsules). Furthermore, under fluorescence microscopy PPFM-microcapsules prepared with 0.5% Ca were more easily observed in the bright field channel compared to 0.1% Ca microcapsules, suggesting that highly cross-linked microcapsules remained more physically intact.

### Example 5 Viability of PPFM in Spray-Dried Powders

The viability of PPFMs was tracked over the course of the microencapsulation process. The microbial population was enumerated in the shake flask culture, in the inlet suspension containing the cell pellet dispersed in the alginate solution, in the waste supernatant from the shake flask, and in the spray-dried powder. Shake flask cultures were consistently grown to approximately 10⁹ CFU/ml, and the microbial population per fluid volume was not significantly reduced when the cell pellet was re-suspended in the same volume of alginate solution. The spray-dried 0.1% Ca and 0.5% Ca PPFM-microcapsules contained 1.2×10¹⁰ CFU/g and 1.1×10¹⁰ CFU/g, respectively, adjusted for moisture content. This constituted a 0.46±0.73 and 0.48±0.29 log CFU/g reduction relative to the population per dry mass in the spray-dryer inlet suspensions used to prepare the 0.1% and 0.5% Ca PPFM-microcapsules, respectively. Thus, the spray-drying step did not significantly reduce the viable PPFM population in either group. The total microbial population was calculated at each step of the microencapsulation process to provide a common basis for comparison. There was no significant difference in the total PPFM populations in the shake culture growth media, spray-dryer inlet suspension, and resultant powder; however, the population in the waste supernatant was two orders of magnitude lower than the population in the shake flask, indicating that cell losses during the separation step were negligible. The concentration of CaHPO₄ in the inlet suspension did not significantly influence the survival of PPFMs at any stage of the microencapsulation process.

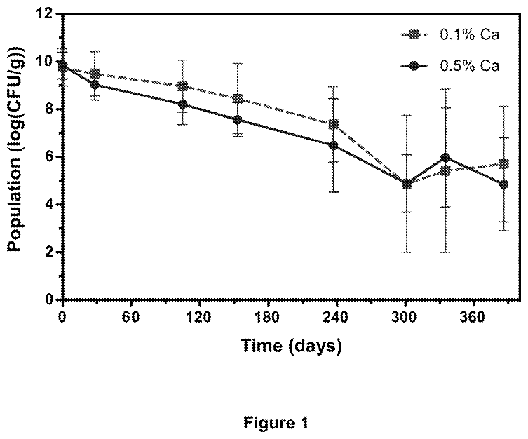

The population of PPFMs in CLAMs was monitored periodically over the course of one year of bench top storage. As shown in FIG. 1, the average viable population declined gradually over the course of 12 months, with 0.1% Ca CLAMs experiencing a 4 log CFU/g reduction and 0.5% Ca CLAMs experiencing a 5 log CFU/g reduction. The triplicate batches of both formulations experienced considerable variation in surviving PPFM population, particularly beyond 6 months of storage. In individual batches, PPFM populations exceeding 10⁶ and as high as 4.8×10⁷ CFU/g persisted over one year of storage in CLAMs. However, replicate lots with populations below 10⁴ CFU/g decreased the average survival values and led to the high variances. The CaHPO₄ content did not appear to influence the survival of PPFMs in CLAMs over the storage period.

### Example 6 Spray Dried PPFM Compositions with a Hydrophobic Compound

Production of a spray dried alginate microcapsule PPFM composition containing a hydrophobic compound is described. A microbial pellet of ISO02 (NRRL B-50930), was prepared as described in Example 1. Dry cross-linked alginate microcapsules were prepared as follows. A well-mixed suspension of 2.0% (w/w) sodium alginate, 0.5% (v/v) latex, 1.0% (w/w) succinic acid (adjusted to pH 5.6 with ammonium hydroxide), and insoluble calcium phosphate dibasic dihydrate (CaHPO₄) at a concentration of 0.1% (w/w) was prepared. The microorganism pellet was dispersed in this inlet suspension, which was subsequently pumped into a Buchi B290 laboratory spray-dryer (New Castle, Del.) to produce dry, bacteria-loaded microcapsules. All formulations were prepared under identical operating conditions: inlet air temperature was set to 130° C., aspirator airflow rate was set to maximum (35 m3/h), peristaltic pump was set to 45% of maximum, and nozzle air flow was set to 50 mm on the Q-flow indicator. Under these conditions, the outlet temperatures ranged from 49-53° C.

The population of PPFMs in the spray-dried powders was monitored periodically over the course of greater than 9 months of storage at room temperature. Results are shown in Table 3 below. The average viable population declined gradually over the course of 9 months, with populations prepared using 0.5% latex experiencing a 4 log CFU/g reduction and those prepared with 0.05% latex experiencing a 5 log CFU/g reduction.

TABLE 3

| NLS | | Days After | Titer | |
|---|---|---|---|---|
| Number: | % Latex | Treatment | Date: | CFU/1g |
| NLS0020 | 0.05% | 2 | Oct. 3, 2016 | 1.06E+10 |
| NLS0020 | 0.50% | 1 | Oct. 3, 2016 | 8.65E+09 |
| NLS0020 | 0.05% | 38 | Nov. 7, 2016 | 2.40E+09 |
| NLS0020 | 0.50% | 38 | Nov. 7, 2016 | 1.76E+10 |
| NLS0020 | 0.05% | 84 | Dec. 22, 2016 | ND |
| NLS0020 | 0.50% | 84 | Dec. 22, 2016 | 1.17E+08 |
| NLS0020 | 0.05% | 105 | Jan. 11, 2017 | 2.20E+07 |
| NLS0020 | 0.50% | 105 | Jan. 11, 2017 | 8.27E+08 |
| NLS0020 | 0.05% | 126 | Feb. 8, 2017 | 7.62E+06 |
| NLS0020 | 0.50% | 126 | Feb. 8, 2017 | 3.43E+08 |
| NLS0020 | 0.05% | 164 | Mar. 17, 2017 | 6.60E+05 |
| NLS0020 | 0.50% | 164 | Mar. 17, 2017 | 5.00E+07 |
| NLS0020 | 0.05% | 191 | Apr. 12, 2017 | 2.10E+06 |
| NLS0020 | 0.50% | 191 | Apr. 12, 2017 | 7.10E+07 |
| NLS0020 | 0.05% | 220 | May 10, 2017 | 2.00E+06 |
| NLS0020 | 0.50% | 220 | May 10, 2017 | 9.90E+07 |
| NLS0020 | 0.05% | 249 | Jun. 7, 2017 | 1.02E+06 |
| NLS0020 | 0.50% | 249 | Jun. 7, 2017 | 5.52E+07 |
| NLS0020 | 0.05% | 291 | Jul. 18, 2017 | 6.93E+03 |
| NLS0020 | 0.50% | 291 | Jul. 18, 2017 | 8.43E+05 |

### Example 7 Coating Soybean Seeds with Alginate/Latex/PPFM Powders

A powdered composition comprising latex, alginates and PPFM cells was prepared using 0.5% latex as described in Example 6. Soy seeds (50 seeds per treatment) were treated by mixing the powders with a humectant (PEG400, 1% v/v), Florite and water to a final volume of approximately 1 ml, and shaking the seeds and suspension in a 50 ml conical tube to coat the seeds. Various chemicals used in agriculture were layered on to the coated seed in a volume to approximate the label rate for each chemistry. The wet seed was dried in the presence of the chemistry for several days, and CFU/seed was determined at three days after treatment. As shown in Table 4 below, a slight reduction in CFU/seed was seen in response to two of the four formulated chemical active ingredients but the decline is within expected variance.

TABLE 4

| | | | | | | 3-DAT |
|---|---|---|---|---|---|---|
| Agrochemical | Label rate | fl oz | ml | ml/lb | CM/seed | CFU/Seed |
| Macho 600 ST | 1.6-3.2 fl oz/hundred weight | 3.2 | 92.48 | 0.9248 | 1.0E+06 | 1.1E+06 |
| | for soy | | | | | |
| Axyl-Shield | 0.75-1.5 fl oz/hundred weight | 1.5 | 43.35 | 0.4335 | 1.0E+06 | 9.9E+05 |
| | for soy | | | | | |
| Cruiser Maxx | 3.22 fl oz/hundred weight | 3.3 | 95.37 | 0.9537 | 1.0E+06 | 1.8E+05 |
| | for soy | | | | | |
| Rancona Summit | 4 fl oz/hundred weight | 4 | 115.6 | 1.156 | 1.0E+06 | 1.3E+06 |
| | for soy | | | | | |
| Florite 1706 | 1.0 fl oz/hundred weight | 1 | 28.9 | 0.289 | 1.0E+06 | 1.1E+06 |
| | for soy | | | | | |
| Untreated Control 1 | NA | | | | 1.0E+06 | 1.4E+06 |
| Untreated Control 2 | NA | | | | 1.0E+06 | 1.0E+06 |
| Untreated Control 3 | NA | | | | 1.0E+06 | 1.3E+06 |

The population of PPFMs on the coated seeds was monitored periodically over the course of greater than 5 months of storage at room temperature. The average viable population declined gradually over the course of 5 months. As shown in Table 5, PPFM populations declined most rapidly for seeds treated with Axyl Shield (greater than 2 log reduction). Populations on seeds treated with Rancona Summit or Macho 600 ST declined 1 log or less, comparable to control treatments, while those on seeds treated with Cruiser Maxx showed a decline between 2-22 log decline.

TABLE 5

| | Days after | |
|---|---|---|
| Treatment | Treatment | CFU/seed |
| UTC¹ | 2 | 1.43E+06 |
| UTC | 2 | 1.16E+06 |
| Mactio | 2 | 1.31E+06 |
| Axyl | 2 | 1.09E+06 |
| Rancona | 2 | 1.27E+06 |
| Cruizer | 2 | 2.16E+05 |
| UTC | 2 | 1.32E+06 |
| UTC | 66 | 2.69E+04 |
| UTC | 66 | 7.28E+05 |
| Mactio | 66 | 4.84E+05 |
| Axyl | 66 | 1.05E+05 |
| Ramona | 66 | 2.53E+05 |
| Cruizer | 66 | 3.59E+04 |
| UTC | 66 | 1.15E+05 |
| UTC | 102 | 2.39E+04 |
| UTC | 102 | 3.43E+05 |
| Mactio | 102 | 3.80E+05 |
| Axyl | 102 | 4.32E+04 |
| Rancona | 102 | 5.46E+05 |
| Cruizer | 102 | 6.09E+04 |
| UTC | 102 | 1.83E+05 |
| UTC | 131 | 2.99E+04 |
| UTC | 131 | 2.76E+05 |
| Macao | 131 | 2.86E+05 |
| Axyl | 131 | 3.36E+03 |
| Rancona | 131 | 3.87E+05 |
| Cruizer | 131 | 1.38E+04 |
| UTC | 131 | 8.05E+04 |
| UTC | 164 | 1.40E+05 |
| UTC | 164 | 1.90E+05 |
| Mactio | 164 | 1.40E+05 |
| Axyl | 164 | 5.50E+03 |
| Rancona | 164 | 2.30E+05 |
| Cruizer | 164 | 3.70E+04 |
| UTC | 164 | 8.60E+04 |

¹Untreated Control

### Example 8 Coating Corn Seeds with Alginate/Latex/PPFM Powders

A microbial pellet of ISO04(NRRL B-50932), was prepared as described in Example 1. Dry cross-linked alginate microcapsules were prepared as follows. A well-mixed suspension of 2.0% (w/w) sodium alginate, 0.5% (v/v) latex, 1.0% (w/w) succinic acid (adjusted to pH 5.6 with ammonium hydroxide), and insoluble calcium phosphate dibasic dihydrate (CaHPO₄) at a concentration of 0.1% (w/w) was prepared. The microorganism pellet was dispersed in this inlet suspension, which was subsequently pumped into a Buchi B290 laboratory spray-dryer (New Castle, Del.) to produce dry, bacteria-loaded microcapsules. All formulations were prepared under identical operating conditions: inlet air temperature was set to 100° C., aspirator airflow rate was set to maximum (35 m3/h), peristaltic pump was set to 15% of maximum, and nozzle air flow was set to 50 mm on the Q-flow indicator. Under these conditions, the outlet temperatures ranged from 62-64° C. An alginate only sample is prepared as described above, by omitting the latex in the suspension. The population of PPFMs in the spray-dried powders stored at room temperature is monitored periodically. Results from up to 26 days after treatment are provided in Table 6 below.

TABLE 6

| | Days after | | Alginate + |
|---|---|---|---|
| Strain | Treatment | Alginate | Latex |
| NLS0042 | 0 | 2.75E+10 | 6.03E+10 |
| NLS0042 | 5 | 1.48E+10 | 6.56E+10 |
| NLS0042 | 12 | 1.27E+10 | 2.35E+10 |
| NLS0042 | 19 | 8.46E+09 | 2.16E+10 |
| NLS0042 | 26 | 1.97E+10 | 5.96E+10 |

Corn seeds are treated by mixing the alginate latex NLS0042 powders with a humectant (PEG400; 10 ul in a final volume of approximately 1 ml), Florite and water, and applying to coat the seeds. Various chemicals used in agriculture are applied on to the coated seed in a volume to approximate the label rate for each chemistry. The population of viable PPFMs on the coated seeds is monitored periodically to determine viability of the PPFM after storage on corn seed at room temperature.

The breadth and scope of the present disclosure should not be limited by any of the above-described exemplary embodiments, but should be defined only in accordance with the following claims and their equivalents.

What is claimed is:

1. A composition comprising a cross-linked alginate microcapsule (CLAM) which encapsulates at least one plant beneficial gram negative bacterium, wherein the microcapsule comprises at least one hydrophobic compound and wherein the composition further comprises a humectant.

2. The composition of claim 1, wherein the hydrophobic compound is a latex polymer.

3. The composition of claim 1, wherein the humectant is polyethylene glycol.

4. The composition of claim 3, wherein the polyethylene glycol has an average molecular weight of about 40, 100, 200, or 300 to about 500, 600, 800, or 1000 Daltons.

5. The composition of claim 4, wherein the polyethylene glycol has an average molecular weight of about 400 Daltons.

6. The composition of claim 1, further comprising additional agriculturally acceptable adjuvants and/or excipients.

7. The composition of any one of claims 1 to 6, wherein the composition further comprises an insecticide, a nematicide, a fungicide, or any combination thereof.

8. The composition of any one of claims 1 to 6, wherein the composition further comprises a plant fertilizer, a plant micronutrient, or any combination thereof.

9. A method of making a composition comprising combining a cross-linked alginate microcapsule (CLAM) which encapsulates at least one plant beneficial gram negative bacterium with a humectant, wherein the microcapsule comprises at least one hydrophobic compound.

10. The method of claim 9, wherein the CLAM and humectant are additionally combined with an agriculturally acceptable excipient, an additional agriculturally acceptable adjuvant, an insecticide, a nematicide, a fungicide, a plant fertilizer, a plant micronutrient, and/or any combination thereof.

11. A plant part that is coated or partially coated with the composition of any one of claims 1 to 6.

12. The plant part of claim 11, wherein the part is a seed, a leaf, a stem, a flower, a root, or a tuber.

13. The plant part of claim 11, wherein the plant part is a corn, Brassica sp., alfalfa, rice, rye, sorghum, pearl millet, proso millet, foxtail millet, finger millet, sunflower, safflower, soybean, tobacco, potato, peanuts, cotton, sweet potato, cassava, coffee, coconut, pineapple, citrus trees, cocoa, tea, banana, avocado, fig, guava, mango, olive, papaya, cashew, macadamia, almond, sugar beet, sugarcane, oat, barley, tomato, lettuce, green bean, lima bean, pea, cucurbit, ornamental, or conifer plant part.

14. A method of treating a plant or plant part comprising applying a first composition comprising the composition of any one of claims 1 to 6 the plant or plant part.

15. The method of claim 14, wherein the plant part is a corn, Brassica sp., alfalfa, rice, rye, sorghum, pearl millet, proso millet, foxtail millet, finger millet, sunflower, safflower, soybean, tobacco, potato, peanut, cotton, sweet potato, cassava, coffee, coconut, pineapple, citrus tree, cocoa, tea, banana, avocado, fig, guava, mango, olive, papaya, cashew, macadamia, almond, sugar beet, sugarcane, oat, barley, tomato, lettuce, green bean, lima bean, pea, cucurbit, ornamental, or conifer plant part.

16. The method of claim 14, wherein the plant part is a seed.

17. The method of claim 14, wherein a second composition comprising an insecticide, a nematicide, a fungicide, or any combination thereof is applied before, during, and/or after application of the first composition.

18. The method of claim 14, wherein a second composition comprising a plant fertilizer, a plant micronutrient, or any combination thereof is applied before, during, and/or after application of the first composition.

19. A treated plant part obtained by the method of claim 14.
